(19) United States
(12) Patent Application Publication
(10) Pub. No.: US 2018/0264974 A1
(43) Pub. Date: Sep. 20, 2018

(54) SELF-ADJUSTING VEHICLE SEAT

(71) Applicant: Toyota Boshoku America, Inc., Novi, MI (US)

(72) Inventors: Vijayavel Ramachandran, Canton, MI (US); Ron Muniz, Canton, MI (US); Amr Shokry, Novi, MI (US)

(21) Appl. No.: 15/918,185

(22) Filed: Mar. 12, 2018

Related U.S. Application Data
(60) Provisional application No. 62/471,506, filed on Mar. 15, 2017.

(51) Int. Cl. B60N 2/02

(52) U.S. Cl. CPC B60N 2/0244; B60N 2/643; B60N 2002/0268; B60N 2/0232

(57) ABSTRACT

A method of adjusting a vehicle seat includes detecting one of a current position of a vehicle occupant in a vehicle seat with one of a pressure sensitive fabric, a sound transmitter and transducer, and an electromagnetic field transmitter and transducer. A comfortable position is determined of the vehicle occupant. The vehicle seat is adjusted from the current position to the comfortable position. A vehicle seat assembly is also disclosed.

### CROSS-REFERENCE TO RELATED APPLICATION

This application claims priority to U.S. Provisional Application No. 62/471,506 filed on Mar. 15, 2017.

### BACKGROUND OF THE INVENTION

Research indicates that ride sharing will increase and vehicle ownership will decrease over time. As a result, different people will be sitting in a given vehicle seat in a vehicle. Each time a different occupant sits in the vehicle seat, the occupant needs to adjust the vehicle seat to be in his/her comfortable position.

### SUMMARY OF THE INVENTION

In a featured embodiment, a method of adjusting a vehicle seat includes detecting one of a current position of a vehicle occupant in a vehicle seat with one of a pressure sensitive fabric, a sound transmitter and transducer, and an electromagnetic field transmitter and transducer. A comfortable position is determined of the vehicle occupant. The vehicle seat is adjusted from the current position to the comfortable position.

In another embodiment according to the previous embodiment, the vehicle seat includes a back insert, a cushion insert, back bolsters, cushion bolsters, and a sensor that detects the current position of the vehicle occupant. The sensor is located in one of the back insert, the cushion insert, the back bolsters, and the cushion bolsters.

In another embodiment according to any of the previous embodiments, a control module determines the comfortable position of the occupant.

In another embodiment according to any of the previous embodiments, a first signal sent about the current position of the vehicle occupant from the sensor to the control module and a second signal sent from the control module to motors to move at least one of the back insert, the cushion insert, the back bolsters, and the cushion bolsters to position the vehicle seat in the comfortable position.

In another embodiment according to any of the previous embodiments, the step of detecting includes employing the pressure sensitive fabric. The vehicle seat includes foam and an outer trim cover external to the foam. The pressure sensitive fabric is located between the outer trim cover and the foam.

In another embodiment according to any of the previous embodiments, the step of detecting includes employing the pressure sensitive fabric. The vehicle seat includes foam and an outer trim cover external to the foam. The pressure sensitive fabric is an integral part of the outer trim cover.

In another embodiment according to any of the previous embodiments, the step of detecting includes employing a sound transmitter and transducer. The sound transmitter and transducer is embedded in foam of the vehicle seat or attached to a back frame of the vehicle seat.

In another embodiment according to any of the previous embodiments, the step of detecting includes employing a sound transmitter and transducer. The sound transmitter and transducer transmits sound waves that travel through the vehicle occupant and measures a reflected echo.

In another embodiment according to any of the previous embodiments, the step of detecting includes employing the electromagnetic field transmitter and transducer. The electromagnetic field transmitter and transducer is embedded in foam or an outer trim cover of the vehicle seat or is attached to a back frame of the vehicle seat to determine a pressure distribution of the occupant.

In another embodiment according to any of the previous embodiments, the electromagnetic field transmitter and transducer generates a small electromagnetic field that moves around the vehicle occupant.

In another embodiment according to any of the previous embodiments, the step of detecting includes determining a pressure distribution or biometrics of the vehicle occupant.

In another embodiment according to any of the previous embodiments, running an algorithm is included to determine the comfortable position of the vehicle occupant.

In another embodiment according to any of the previous embodiments, repeating the steps of detecting the current position of the vehicle occupant and adjusting the vehicle seat until the vehicle seat is in the comfortable position is included.

In another embodiment according to any of the previous embodiments, when the vehicle occupant is in the comfortable position, a weight of the vehicle occupant is equally distributed.

In another featured embodiment, a vehicle seat assembly includes a sensor that detects the current position of the vehicle occupant in a vehicle seat and sends a first signal to a control module. A component is one of a pressure sensitive fabric, a sound transmitter and transducer, and an electromagnetic field transmitter and transducer. The control module determines the comfortable position of the occupant and sends a second signal to adjust the vehicle seat from the current position to a comfortable position.

In another embodiment according to the previous embodiment, the vehicle seat assembly includes a back insert, a cushion insert, back bolsters, and cushion bolsters. The sensor is located in one of the back insert, the cushion insert, the back bolsters, and the cushion bolsters.

In another embodiment according to any of the previous embodiments, the control module sends the second signal to activate motors to move at least one of the back insert, the cushion insert, the back bolsters, and the cushion bolsters to position the vehicle seat in the comfortable position.

In another embodiment according to any of the previous embodiments, the component is the pressure sensitive fabric. The vehicle seat includes foam and an outer trim cover external to the foam, and the pressure sensitive fabric is located between the outer trim cover and the foam.

In another embodiment according to any of the previous embodiments, the component is the pressure sensitive fabric. The vehicle seat includes foam and an outer trim cover external to the foam. The pressure sensitive fabric is an integral part of the outer trim cover.

In another embodiment according to any of the previous embodiments, the component is the sound transmitter and transducer transmits sound waves that travel through the vehicle occupant and measures a reflected echo. The sound transmitter and transducer is embedded in foam of the vehicle seat or attached to a back frame of the vehicle seat.

In another embodiment according to any of the previous embodiments, the component is the electromagnetic field transmitter and transducer that generates a small electromagnetic field that moves around the vehicle occupant. The electromagnetic field transmitter and transducer is embedded in foam or an outer trim cover of the vehicle seat or is attached to a back frame of the vehicle seat to determine a pressure distribution of the occupant.

### BRIEF DESCRIPTION OF THE DRAWINGS

The above and other features and advantages of the invention will become apparent upon reading the following description taken in conjunction with the accompanying drawings in which:

FIG. 1 is a perspective view of a vehicle seat;

FIG. 2 is a side view of a first example vehicle seat including a pressure sensitive fabric;

FIG. 3 is a cross-section view of an outer covering of the vehicle seat of FIG. 2;

FIG. 4 is a side view of a second example vehicle seat including a sound transmitter and transducer;

FIG. 5 is a side view of a third example vehicle seat including an electromagnetic field transmitter and transducer; and

FIG. 6 illustrates a method of pressure mapping or detecting biometrics of the occupant to adjust the vehicle seat to a comfortable position.

### DETAILED DESCRIPTION OF THE PREERRED EMBODIMENT

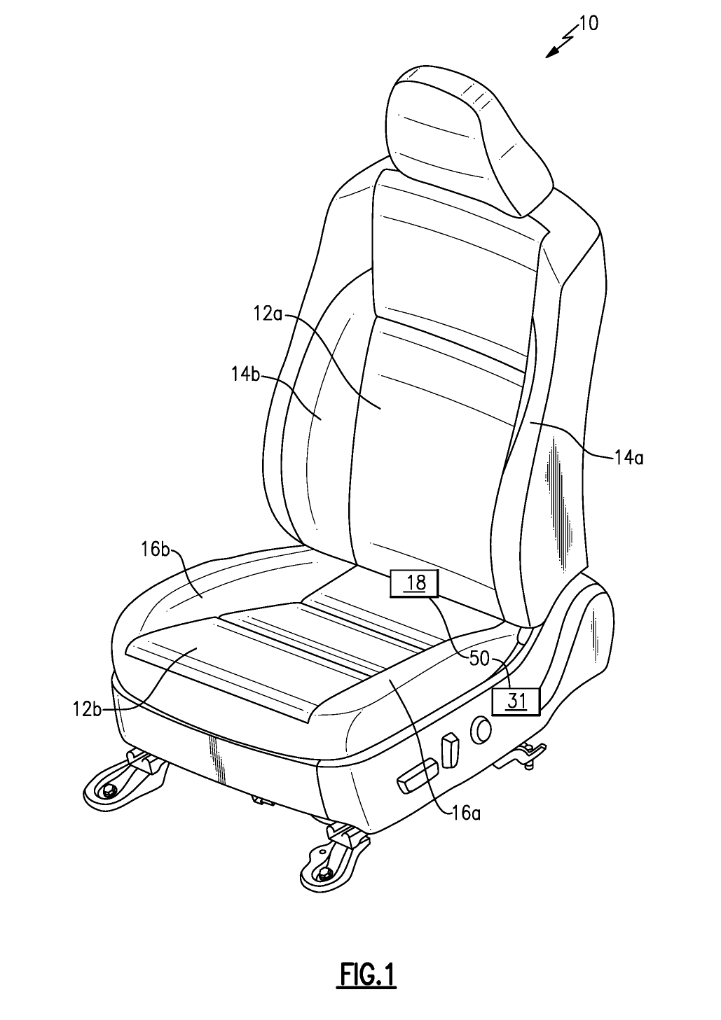

FIG. 1 illustrates a vehicle seat 10. The vehicle seat 10 includes a back insert 12a, a cushion insert 12b, back bolsters 14a and 14b, and cushion bolsters 16a and 16b. At least one sensor 18 (shown schematically) is located in the vehicle seat 10 to study a pressure distribution or biometrics of an occupant. In one example, the sensor 18 is located in one or more of the back insert 12a, the cushion insert 12b, the back bolsters 14a and 14b, and the cushion bolsters 16a and 16b. The vehicle seat 10 also includes a control module 50 that determines a comfortable position of the occupant, and the sensor 18 and the control module 50 communicate and send signals with each other. The control module 50 sends a signal to a motor or motors 31 to move at least one of the back insert 12a, the cushion insert 12b, the back bolsters 14a and 14b, and the cushion bolsters 16a and 16b of the vehicle seat 10 automatically such that the vehicle seat 10 is in the comfortable position for the particular occupant. The vehicle seat 10 can move in any manner that would be readily available by the occupant as well as any other different motion.

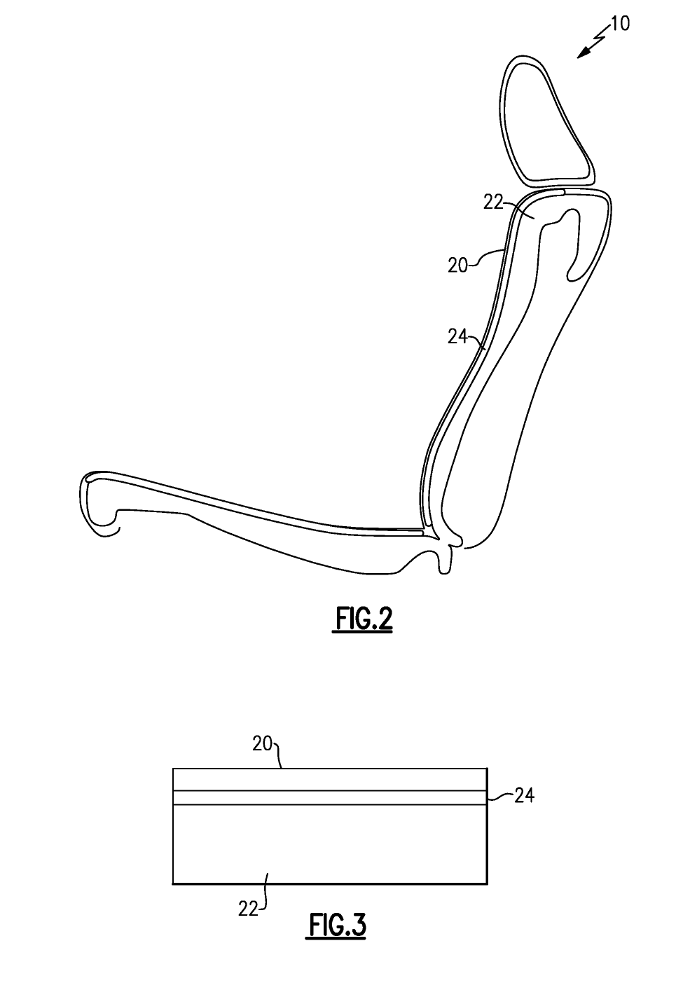

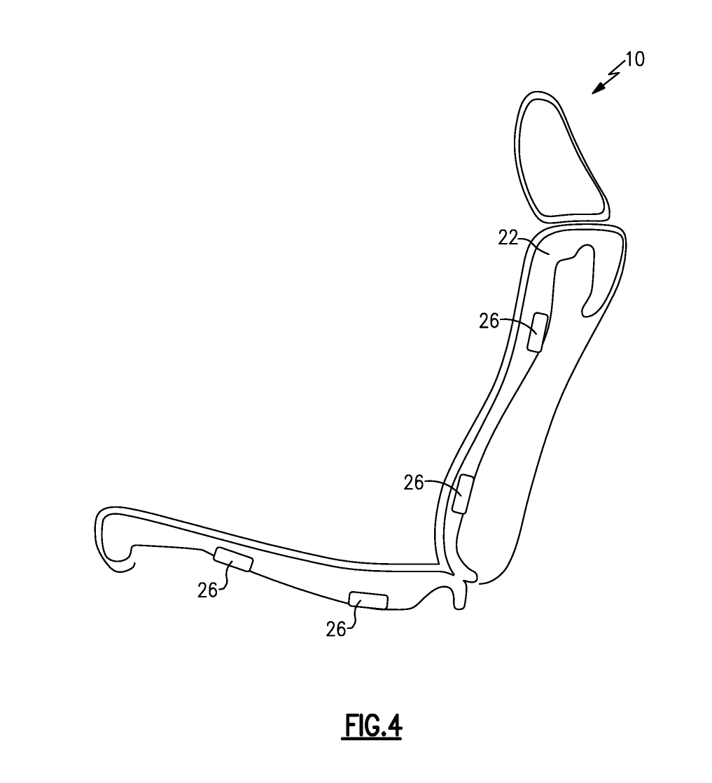

In a first example shown in FIGS. 2 and 3, the vehicle seat 10 includes foam 22 and an outer trim cover 20 that covers or is external to the foam 22. The foam 22 is located inside the vehicle seat 10. A pressure sensitive fabric 24 can be located between the outer trim cover 20 and the foam 22. In another example, the pressure sensitive fabric 24 is an integral part of the outer trim cover 20. The pressure sensitive fabric 24 can be located anywhere in the vehicle seat 10. The pressure sensitive fabric 24 acts as a sensor to determine a pressure distribution of the occupant to determine where and how pressure is applied to the vehicle seat 10.

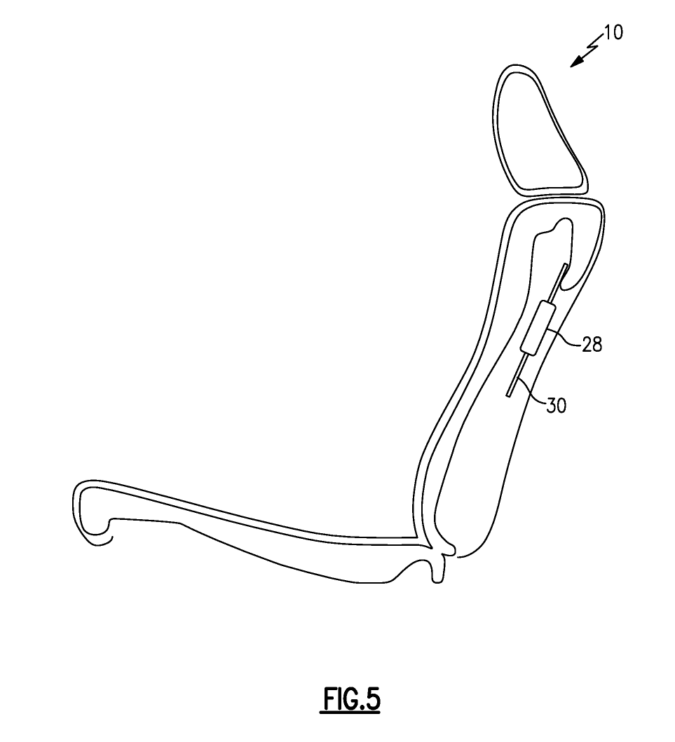

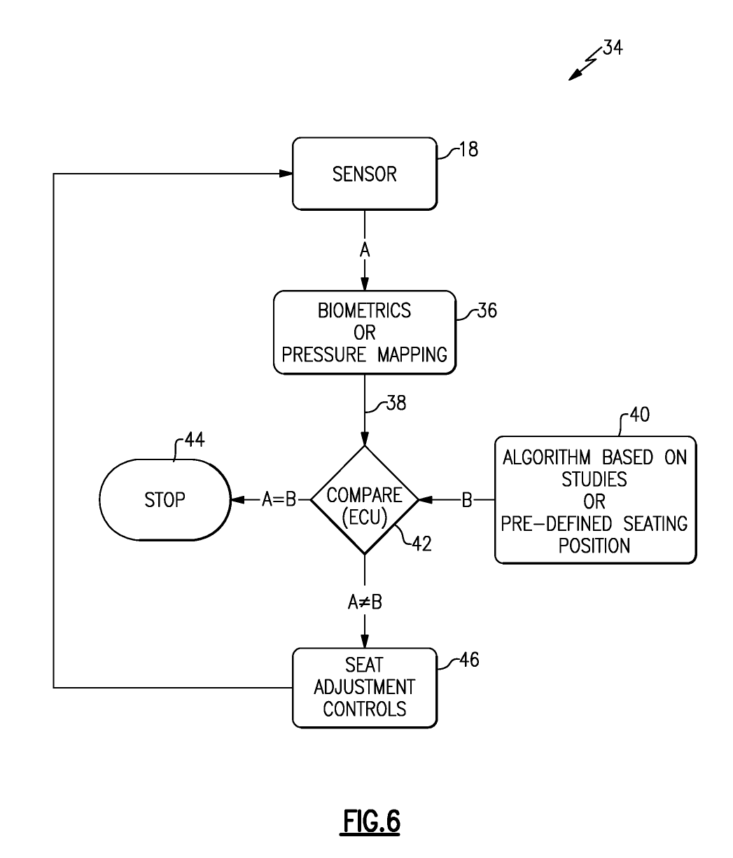

In another example shown in FIG. 4, the vehicle seat 10 includes a sound transmitter and transducer 26. The sound transmitter and transducer 26 uses sound waves to act as a sensor. The sound transmitter and transducer 26 is embedded in the foam 22 of the vehicle seat 10. In another example, the sound transmitter and transducer 26 is attached to a back frame 30 (shown in FIG. 5). Sound waves are transmitted through the occupant, and a reflected echo is then measured to get biometrics and the posture of the occupant, including where and how a pressure distribution of the occupant is applied to the vehicle seat 10. The sound transmitter and transducer 26 can be found anywhere in the vehicle seat 10. Additionally, there can be more than one sound transmitter and transducer 26.

In another example shown in FIG. 5, the vehicle seat 10 includes an electromagnetic field transmitter and transducer 28 that is attached to a back frame 30 (part of the seat structure). The electromagnetic field transmitter and transducer 28 generates a small electromagnetic field that moves around the occupant. Changes in tissue expansion and contraction is measured to get biometrics and possibly the posture of the occupant to determine where and how the pressure distribution is applied to the vehicle seat 10. In one example, the electromagnetic field transmitter and transducer 28 is located in the foam 22 or the outer trim cover 20 of the vehicle seat 10.

FIG. 6 shows a flow diagram of the method 34 of determining a pressure distribution or detecting biometrics of the occupant to adjust the vehicle seat 10 to the comfortable position. In step 36, the sensor 18 (either the pressure sensitive fabric 24, the sound transmitter and transducer 26 or the electromagnetic field transmitter and transducer 28) detects the pressure distribution or biometrics of the occupant in the vehicle seat 10 to determine a current detected position A.

In step 38, the sensor 18 detects a position of an occupant and sends a signal about a detected position A to the control module 50. The control module 50 runs an algorithm 40 to determine a comfortable position B of the occupant based on the parameters detected by the sensor 18. The algorithm is based on studies or pre-defined seating position. The algorithm is programmed into the control module 50. Several pressure points on the vehicle seat are higher than the others.

The control module 50 then compares the detected position A to the comfortable position B. When the control module 50 determines that the detected position A is the same as the comfortable position B, the vehicle seat 10 stops adjusting, and the method is stopped at step 44. For example, when a weight of the occupant is equally distributed, the occupant is in the comfortable position B. If the detected position A is not the same as the comfortable position B, the vehicle seat 10 is adjusted in step 46. The method 34 continues and repeats until the detected position A is the comfortable position B.

In step 46, based on the detected position A of the vehicle seat 10, the control module 50 determines how to move the vehicle seat 10. At least one motor 31 or driver moves the back insert 12a, the cushion insert 12b, the back bolsters 14a and 14b, and the cushion bolsters 16a and 16b to position the vehicle seat 10 to the comfortable position B so that the weight of the occupant is equally distributed on the vehicle seat 10.

The method 34 can also be repeated after a set amount of time programmed into the control module 50. Additionally, the method 34 can be repeated when a new occupant is detected sitting in the vehicle seat 10. Finally, the method 34 can be repeated when motion or movement is detected. That is, the method 34 can be repeated when any data obtained by the sensor 18 changes. As a result, the control module 50 continually monitors the data about the pressure distribution or biometrics of the occupant.

The vehicle seat 10 can be adjusted to the comfortable position A without any user intervention. As a result, the vehicle seat 10 can have a one size fits all design as it will automatically run the method 34 to automatically adjusting the back insert 12a, the cushion insert 12b, the back bolsters 14a and 14b, and the cushion bolsters 16a and 16b of the vehicle seat 10 to the comfortable position A of the given occupant.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A method of adjusting a vehicle seat, the method comprising:
detecting one of a current position of a vehicle occupant in a vehicle seat with one of a pressure sensitive fabric, a sound transmitter and transducer, and an electromagnetic field transmitter and transducer;
determining a comfortable position of the vehicle occupant; and
adjusting the vehicle seat from the current position to the comfortable position.

2. The method as recited in claim 1 wherein the vehicle seat includes a back insert, a cushion insert, back bolsters, cushion bolsters, and a sensor that detects the current position of the vehicle occupant, wherein the sensor is located in one of the back insert, the cushion insert, the back bolsters, and the cushion bolsters.

3. The method as recited in claim 2 wherein a control module determines the comfortable position of the occupant.

4. The method as recited in claim 3 including sending a first signal about the current position of the vehicle occupant from the sensor to the control module and sending a second signal from the control module to motors to move at least one of the back insert, the cushion insert, the back bolsters, and the cushion bolsters to position the vehicle seat in the comfortable position.

5. The method as recited in claim 1 wherein the step of detecting comprises employing the pressure sensitive fabric, the vehicle seat includes foam and an outer trim cover external to the foam, and the pressure sensitive fabric is located between the outer trim cover and the foam.

6. The method as recited in claim 1 wherein the step of detecting comprises employing the pressure sensitive fabric, the vehicle seat includes foam and an outer trim cover external to the foam, and the pressure sensitive fabric is an integral part of the outer trim cover.

7. The method as recited in claim 1 wherein the step of detecting comprises employing a sound transmitter and transducer, wherein the sound transmitter and transducer is embedded in foam of the vehicle seat or attached to a back frame of the vehicle seat.

8. The method as recited in claim 1 wherein the step of detecting comprises employing a sound transmitter and transducer, wherein the sound transmitter and transducer transmits sound waves that travel through the vehicle occupant and measures a reflected echo.

9. The method as recited in claim 1 wherein the step of detecting comprises employing the electromagnetic field transmitter and transducer, wherein the electromagnetic field transmitter and transducer is embedded in foam or an outer trim cover of the vehicle seat or is attached to a back frame of the vehicle seat to determine a pressure distribution of the occupant.

10. The method as recited in claim 1 wherein the electromagnetic field transmitter and transducer generates a small electromagnetic field that moves around the vehicle occupant.

11. The method as recited in claim 1 wherein the step of detecting comprises determining a pressure distribution or biometrics of the vehicle occupant.

12. The method as recited in claim 1 including running an algorithm to determine the comfortable position of the vehicle occupant.

13. The method as recited in claim 1 including repeating the steps of detecting the current position of the vehicle occupant and adjusting the vehicle seat until the vehicle seat is in the comfortable position.

14. The method as recited in claim 1 wherein when the vehicle occupant is in the comfortable position, a weight of the vehicle occupant is equally distributed.

15. A vehicle seat assembly comprising:
a sensor that detects the current position of the vehicle occupant in a vehicle seat and sends a first signal to a control module;
a component that is one of a pressure sensitive fabric, a sound transmitter and transducer, and an electromagnetic field transmitter and transducer; and
the control module that determines the comfortable position of the occupant and sends a second signal to adjust the vehicle seat from the current position to a comfortable position.

16. The vehicle seat assembly as recited in claim 15 wherein the vehicle seat assembly includes a back insert, a cushion insert, back bolsters, and cushion bolsters, wherein the sensor is located in one of the back insert, the cushion insert, the back bolsters, and the cushion bolsters.

17. The vehicle seat assembly as recited in claim 16 wherein the control module sends the second signal to activate motors to move at least one of the back insert, the cushion insert, the back bolsters, and the cushion bolsters to position the vehicle seat in the comfortable position.

18. The vehicle seat assembly as recited in claim 15 wherein the component is the pressure sensitive fabric, the vehicle seat includes foam and an outer trim cover external to the foam, and the pressure sensitive fabric is located between the outer trim cover and the foam.

19. The vehicle seat assembly as recited in claim 15 wherein the component is the pressure sensitive fabric, the vehicle seat includes foam and an outer trim cover external to the foam, and the pressure sensitive fabric is an integral part of the outer trim cover.

20. The vehicle seat assembly as recited in claim 15 wherein the component is the sound transmitter and transducer transmits sound waves that travel through the vehicle occupant and measures a reflected echo, wherein the sound transmitter and transducer is embedded in foam of the vehicle seat or attached to a back frame of the vehicle seat.

21. The vehicle seat assembly as recited in claim 15 wherein the component is the electromagnetic field transmitter and transducer that generates a small electromagnetic field that moves around the vehicle occupant, wherein the electromagnetic field transmitter and transducer is embedded in foam or an outer trim cover of the vehicle seat or is attached to a back frame of the vehicle seat to determine a pressure distribution of the occupant.
